(19) United States
(12) Patent Application Publication
(10) Pub. No.: US 2008/0089750 A1
(43) Pub. Date: Apr. 17, 2008

(54) Universal Turning and Milling Tool

(76) Inventor: Hsin-Tien CHANG, Tai-Ping City (TW)

Correspondence Address: Dr. BANGER SHIA;Int''l Patent Office of Bang Shia, 102 Lindencrest Ct, Sugar Land, TX, 77479-5201, US

(21) Appl. No.: 11/549,689

(22) Filed: Oct. 16, 2006

(51) Int. Cl. B23P 15/28

(52) U.S. Cl. 407/103

(57) ABSTRACT

A universal turning and milling tool applied in turning, milling, and drilling includes a tool blade with one end disposed with a holder to accommodate a disposable insert to be locked in the holder with a screw; a threaded hole being disposed at the center of the holder; a bevel angle θ inclined downward being defined by the surface of the holder and the turning central line (T.C.L.) of the tool; and the proper bevel angle θ being defined between a screw hole central line (S.C.L.) of the threaded hole and the T.C.L of the tool; the S.C.L. of the threaded hole of the holder straying from the T.C.L. of the tool for a mild distance; and only a cutting edge of the insert straying from the T.C.L. operates to cut and another cutting edge on the other side of the insert is idled when the tool revolves.

### BACKGROUND OF THE INVENTION

(a) Field of the Invention

The present invention is related to a universal turning and milling tool, and more particularly, to a tool applicable to milling, turning and drilling with the same tool during the process with a CNC Lathe with Milling Machine.

(b) Description of the Prior Art

As illustrated in FIG. 18 of the accompanied drawings, turning by a general lathe operates by having a work piece 61 to revolve and a tool 62 fixed to a holder 63 to travel for cutting off certain parts of the work piece 61 as it revolves to change the appearance of the work piece 61 as designed. As illustrated in FIG. 19, a milling machine operates to have a work piece 65 held in position and a tool 64 revolves to remove certain parts of the work piece 65. Therefore, both turning and milling operates in different fashions with different tooling machines. Designs respectively for both tools fall in different technical fields and are prevented from being interchangeable.

Now referring to FIG. 20, a base 71 of a cutting tool 70 of the prior art is laterally disposed, i.e., the base 71 is in parallel with the turning central line (T.C.L.) of the cutting tool 70; therefore, the thickness t0 of the bottom of the base 71 is very small to prevent heavy turning process, a common problem the conventional cutting tool fails to overcome.

As the type of process changes, mechanical parts tend to get more sophisticate and demands of dimensional precision gets more strict. CNC lathe with milling machine is capable of turning, milling, and drilling process to upgrade precision of the dimension of a complicate work piece. For example, in a process for a complicate work piece as illustrated in FIGS. 6 and 7, a part 40 is disposed at its end surface a central hole 411, and a thread 42, a groove 43, an inclined plane 44, a V-groove 45, a polygon 46, a central hole 47, an long oval groove 48, an engraved trade name 49 on the other end surface. The part may be provided in diversified shapes including round or square caber in one. To process such a work piece in a complicate form, many tools including dimensional turning tool, center drill, tooth cutting tool, and slot cutting tool must prepared even when the CNC lathe with milling machine is used. Furthermore, the plane milling tool, drill bit, chamfer cutting tool, end-milling tool for a milling system must be prepared. The cost just to maintain those cutting tools in great number alone is very high. The process is described as follows:

Referring to FIG. 21, a raw material is gradually removed of its residual portions into a column 400 using a dimensional cutting tool T1 (the first tool). A second tool (V-tool T2) is used to cut the raw material a V shaped groove 45 as illustrated in FIG. 22. The column 400 is separated into two parts as illustrated in FIG. 23, and a third tool T3 (an end milling) is used to mill the column 400 into two polygons 46 at different angles. The surface of a polygon 46 is drilled a central hole 47 using a center drilling bit T4 (the fourth tool) as illustrated in FIG. 24 and a end milling tool T5 (the fifth tool) is used to mill a rectangular groove 48 as illustrated in FIG. 25. A milling designated chamfer tool T6 (the sixth tool) is used to mill an arc edge as illustrated in FIG. 26. On the end surface of the raw material, an engraving tool T7 (the seventh tool) is used to mill multiple letters as illustrated in FIG. 25. As illustrated in FIG. 27, another end of the raw material 4 is milled a column 401 and an inclined plane 44 with the dimensional tool T1; and a slotting tool T8 (the eighth tool) is used to turn a round groove 43 at where between the inclined plane 44 and the column. An arc tool T9 (the ninth tool) dedicated for turning is used to chamfer an arc 50 on the end surface of the raw material. A thread tool T10 (the tenth tool) is used to turn a thread 42; and finally the center drill bit T4 (the fourth tool) is used to drill the central hole 41 on the end surface of the raw material.

As described above, nine tools and twelve steps are required to process the part 40. The tool (e.g., the dimensional tool) dedicated for the lath cannot be adapted to the milling machine, and vice versa. Therefore, a great number of tools must be prepared and the maintenance cost gets very high. That's a major flaw for the traditional tool in machining process.

### SUMMARY OF THE INVENTION

The primary purpose of the present invention is to provide a universal turning and milling tool capable of being adapted to a milling machine to execute milling and drilling, and to a lathe for executing turning processes; and the same tool is capable of executing turning, milling, and drilling processes when adapted to a CNC lathe with milling machine. To achieve the purpose; a screw hole center line (S.C.L.) defined for the base of the tool is not overlapped with the turning central line (T.C.L.) of the tool; instead, it strays from T.C.L. for a mild distancee ranging from 0.1˜0.25 mm for a disposable insert to merely permit a cutting edge a to effect cutting when the tool revolves and the cutting edge b on the other side is idled. If four cutting edges are available for each disposal insert, the insert is given with four folds of service life while two cutting edges are available from the conventional double-edged insert. Therefore, the present invention provides a service life that is twice of the conventional one.

A proper inclination θ is defined between the tool holder and the T.C.L. of the tool for the disposal insert to be placed at an inclination with its tip remaining to stay on the T.C.L. of the tool. The inclined holder increases the thickness t of the blade behind the holder to naturally upgrade the rigidity of the blade, and thus the milling and drilling capabilities of the tool.

The same tool of the present invention can be adapted to a lath and milling machine for machining process. When applied in the process with a lathe, drilling machine and lath, the insert of the tool of the present invention allows the design of a disposal insert. Therefore, the tool can be adapted with disposal inserts of various functions to complete the corresponding process. For example, a turning insert, a grooving insert, or a centering insert can be adapted to a lathe while a centering insert or a face milling insert can be adapted to a milling machine to execute drilling, chamfering, engraving, and face milling.

### BRIEF DESCRIPTION OF THE DRAWINGS

FIG. 1 is a perspective view of the present invention.

FIG. 2 is a side view of the present invention.

FIG. 3 is a bird's eye view of the present invention.

FIG. 4 is a front view of the present invention.

FIG. 5 is a schematic view of the turning range by a cutting edge of a disposal insert in the present invention.

FIG. 6 is a perspective view showing a preferred embodiment of turning with the present invention.

FIG. 7 is a perspective view taken at another view angle of the turning with the preferred embodiment of the present invention.

FIG. 8 is a schematic view showing an application of external turning with the present invention.

FIG. 9 is a schematic view showing an application of V-groove turning with the present invention.

FIG. 10 is a schematic view showing an application of milling a polygon with the present invention.

FIG. 11 is a schematic view showing an application of drilling a central hole with the present invention.

FIG. 12 is a schematic view showing an application of chamfer milling on a polygon external turning with the present invention.

FIG. 13 is a schematic view showing applications of milling a long oval groove and engraving letters with the present invention.

FIG. 14 is a schematic view showing applications of spiffy corner turning on the end surface and turning an inclined plane with the present invention.

FIG. 15 is a schematic view showing an application of drilling a central hole on the end surface with the present invention.

FIG. 16 is a schematic view showing an application of turning a round groove with the present invention.

FIG. 17 is a schematic view showing an application of turning a thread with the present invention.

FIG. 18 is a schematic view showing an application of external turning of a raw material with a conventional external tool.

FIG. 19 is a schematic view showing an application of milling a workpiece with a conventional milling tool.

FIG. 20 is a side view of the conventional milling tool.

FIG. 21 is a schematic view showing applications of turning a inclined place and end-face with a conventional milling tool.

FIG. 22 is a schematic view showing an application of external turning of a V-groove by a conventional V-tool.

FIG. 23 is a schematic view showing an application of milling a polygonal with a conventional end-milling tool.

FIG. 24 is a schematic view showing an application of drilling of a central hole with a conventional centering drill bit.

FIG. 25 is a schematic view showing milling applications of turning a long oval groove and engraving letters with a conventional end-milling tool.

FIG. 26 is a schematic view showing an application of chamfering a polygonal plane with a conventional chamfer-milling tool.

FIG. 27 is a schematic view showing applications of turning a round groove, spiffy corner, inclined place and thread with a conventional tool.

### DETAILED DESCRIPTION OF THE PREFERRED EMBODIMENTS

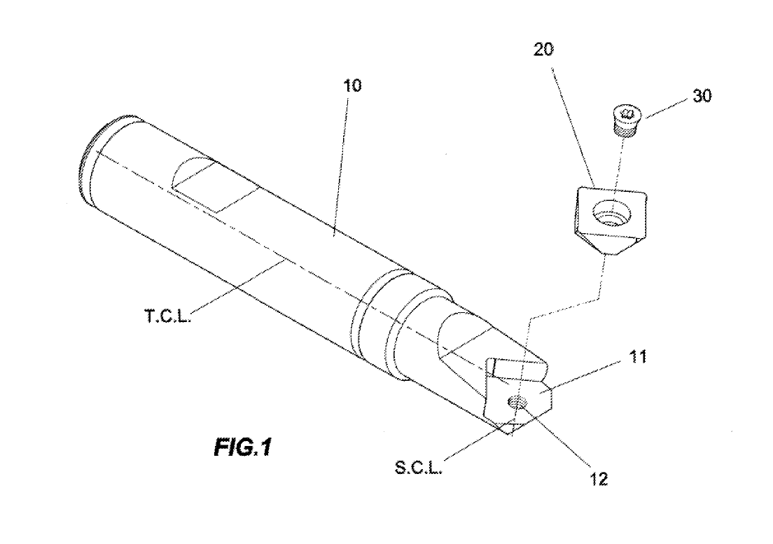

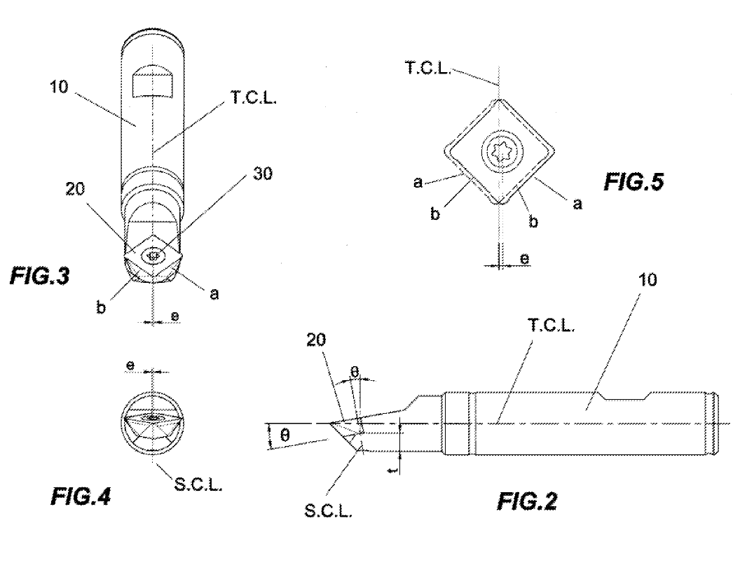

Referring to FIGS. 1 and 2, a universal turning and milling tool of the present invention includes a tool body 10 with one end disposed with a holder 11 to accommodate a disposable insert 20; the disposable insert 20 is locked inside the holder 11 with a screw 30; and a thread hole 12 is disposed at the center of the holder 11. The surface of the holder 11 is not in parallel with the turning central line (T.C.L.) of the tool; instead, a bevel angle θ inclining downward is defined. Accordingly the S.C.L of the thread hole is not perpendicular to the T.C.L. of the tool; instead, a proper bevel angle θ is defined between the thread hole and the T.C.L. of the tool.

Now referring to FIGS. 3, 4, and 5, the S.C.L. of the holder 11 does not overlap with the T.C.L. of the tool; instead, the S.C.L. of the holder 11 strays from the T.C.L. for a mild distance e, approximately in the range of 0.1˜0.25 mm so that when the tool is revolving, only a cutting edge a of the disposable insert 20 straying from the T.C.L. gives cutting capability while the other cutting edge b on the opposite side is idled.

As for the mild eccentric placement of the disposable insert as illustrated in FIGS. 3 and 5, the disposable insert 20 is locked at where provides a mild divulged distancee from the T.C.L., and a range of approximately 0.1˜0.25 mm is sufficient. Therefore, only the cutting edge a straying from the T.C.L. is doing the cutting when the tool body 10 revolves while another cutting edge b on the opposite side is revolving within the cutting radius without executing any cutting or creating friction and consumption with the work piece. Accordingly, each cutting edge of the disposable insert 20 is used alone and in the preferred embodiment, four cutting edges are available, meaning the same insert allows four times of replacement to achieve the optimal cost benefits.

For the design of inclined holder as illustrated in FIGS. 2 and 5, a proper bevel angle θ is defined between the holder 11 and the T.C.L. of the tool. The bevel angle θ causes the disposal insert 20 to be placed at an inclination with its tip remains to fall on the T.C.L. of the tool. The inclined holder 11 further increases the thickness t of the blade behind the holder 11 to naturally upgrade the rigidity of the blade. Compared with a thickness t0 of a horizontal holder 71 of the conventional tool as illustrated in 20 is greater than t of the blade to naturally further upgrade milling and drilling capabilities.

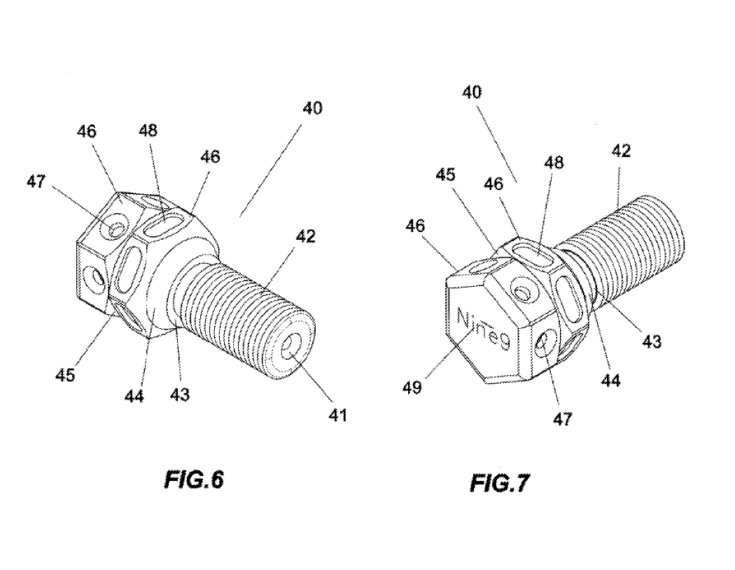

The tool of the present invention can be adapted with various types of disposable insert to carry out different machining processes of turning, milling, and drilling with the same tool. Multiple types of process can be carried out with the same disposable insert or another disposable insert of different functions to simplify the process time and procedure for reduction of production cost. A part 40 as illustrated in FIGS. 6 and 7 is used to verify advantages of the present invention with detailed process procedure to be described as follows.

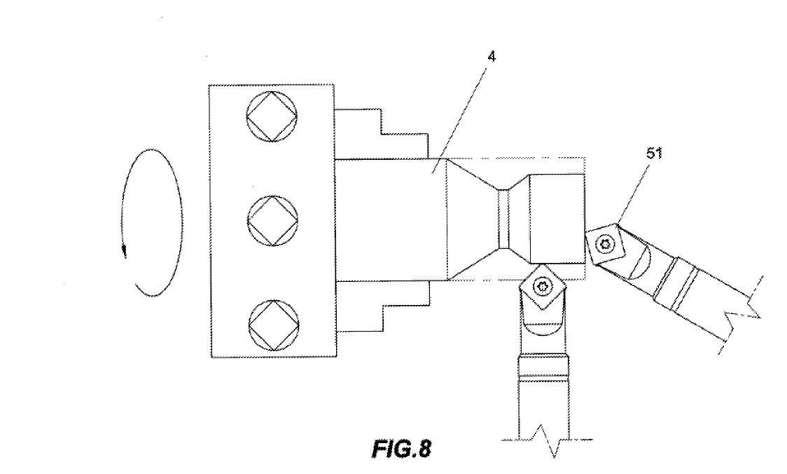

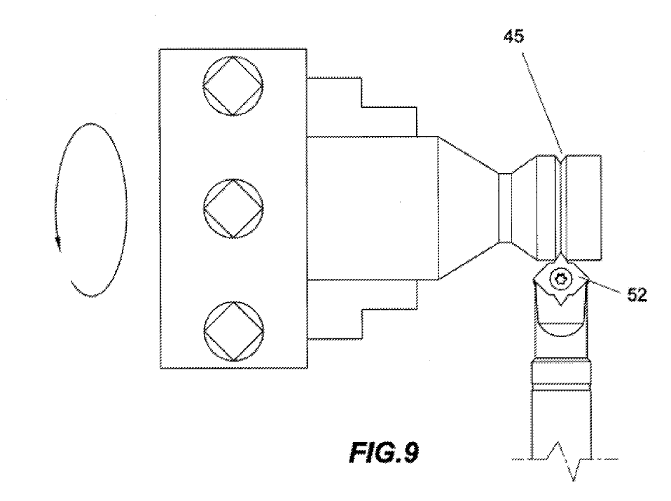

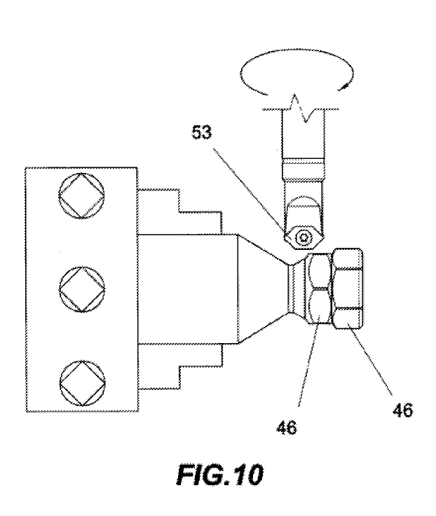

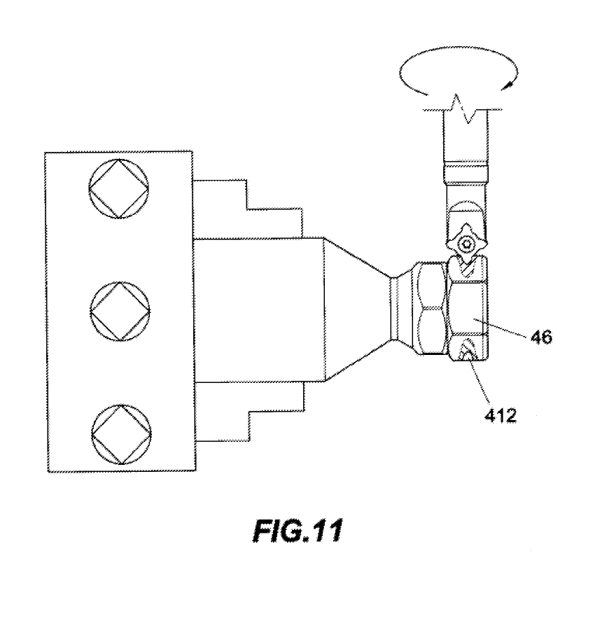

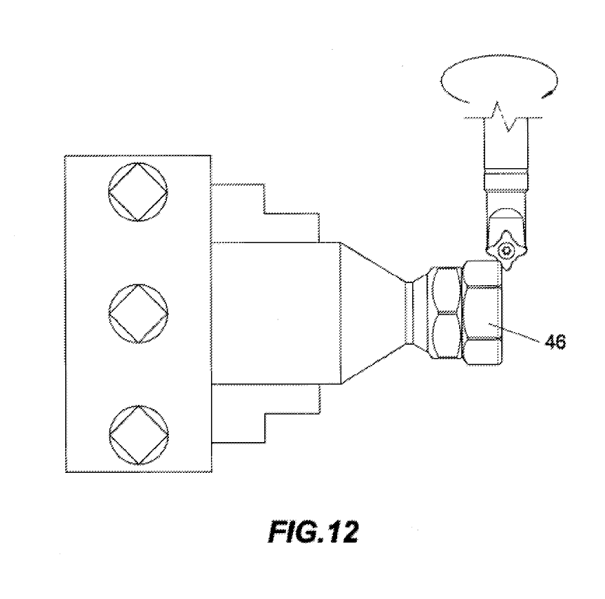

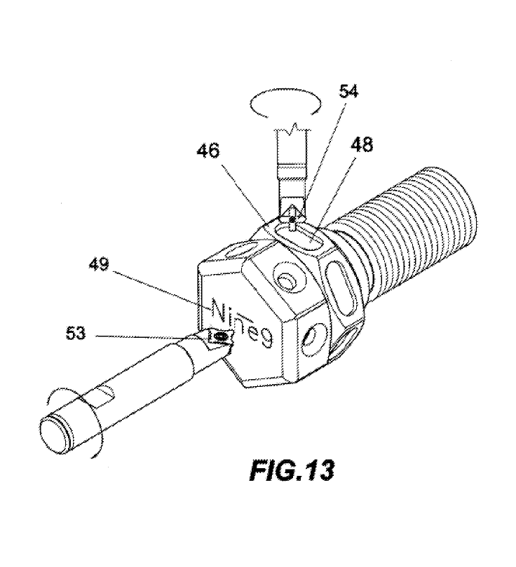

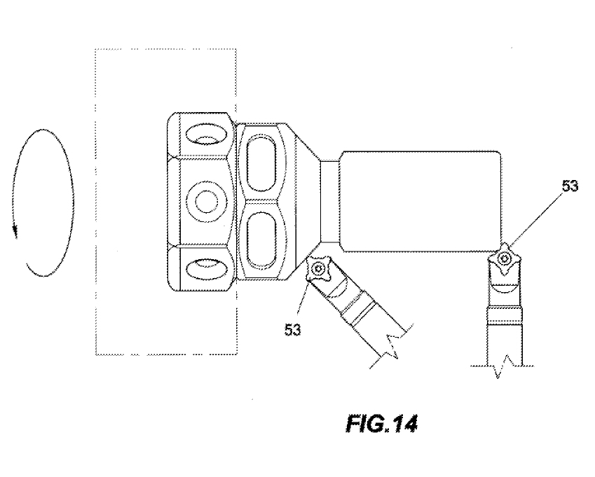

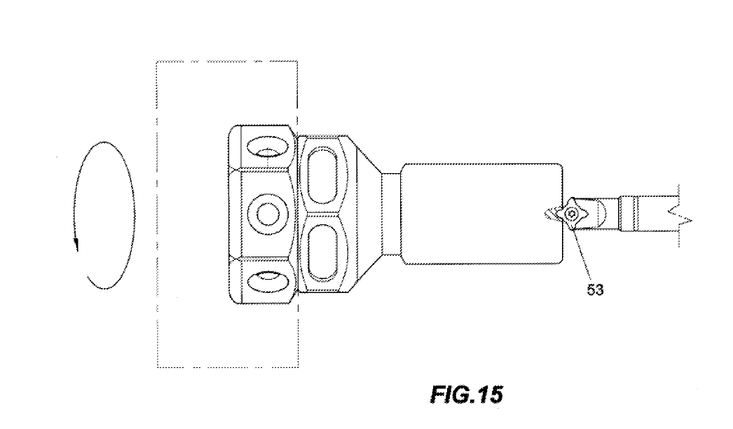

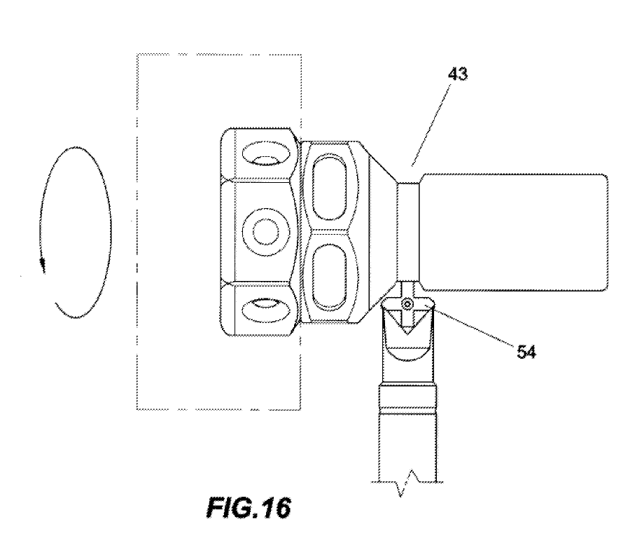

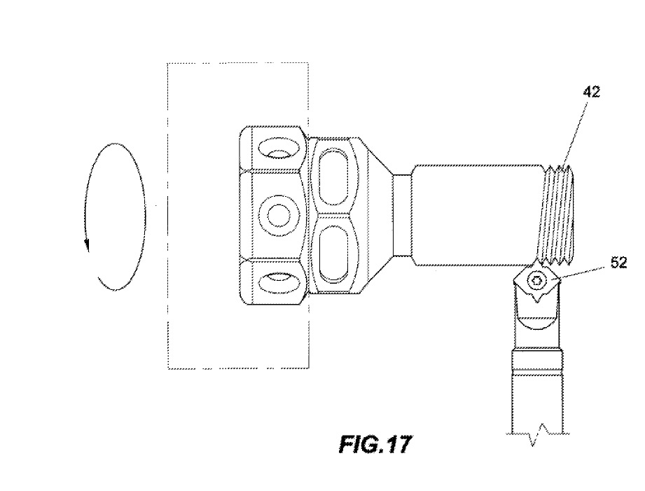

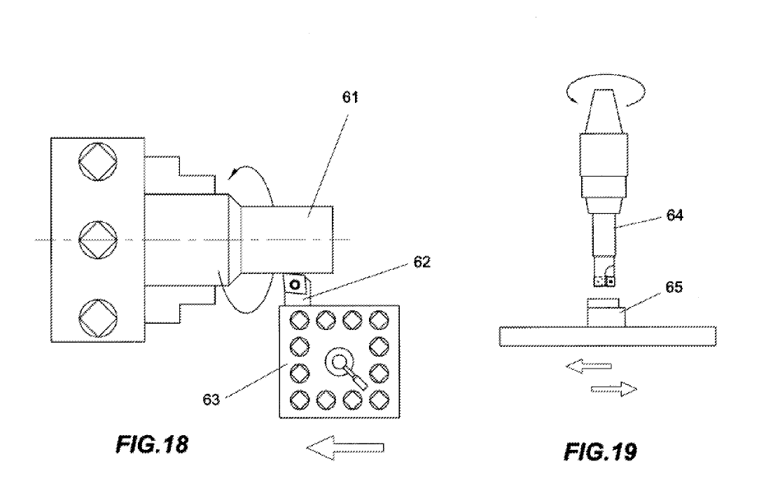

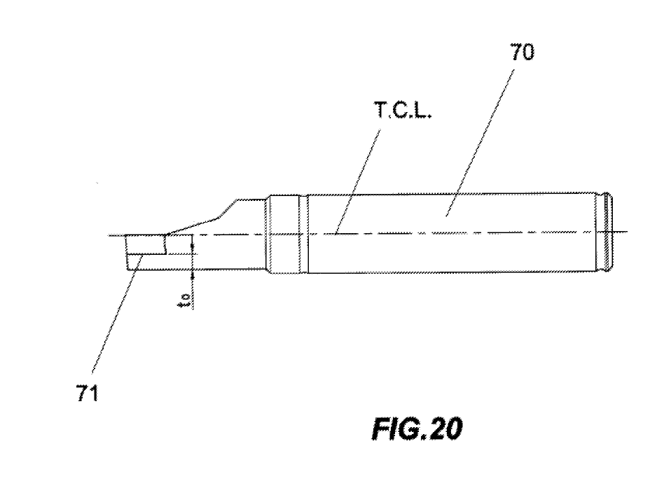

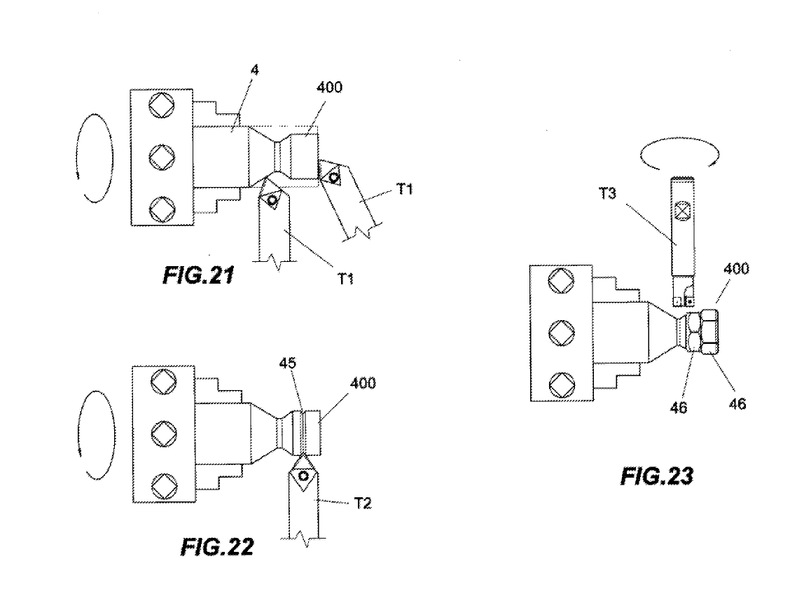

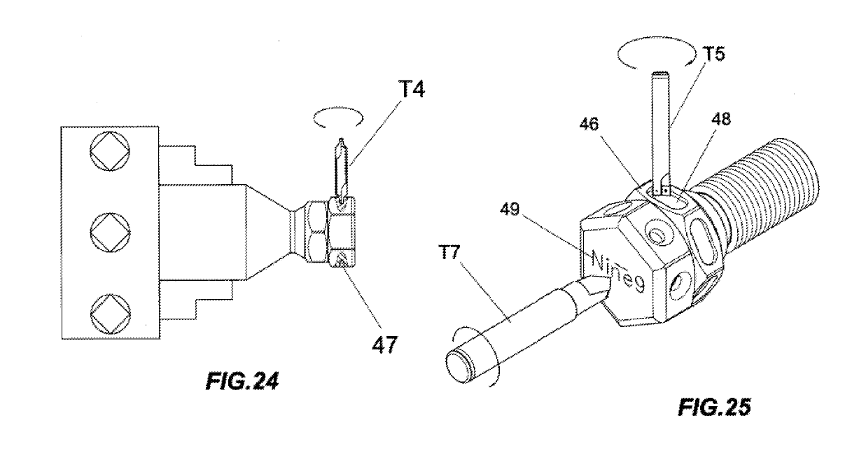

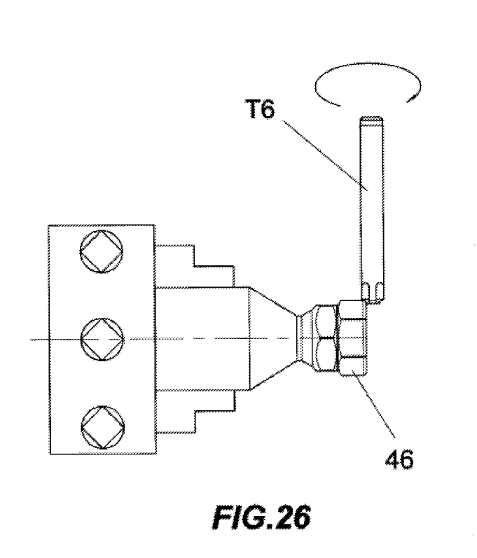

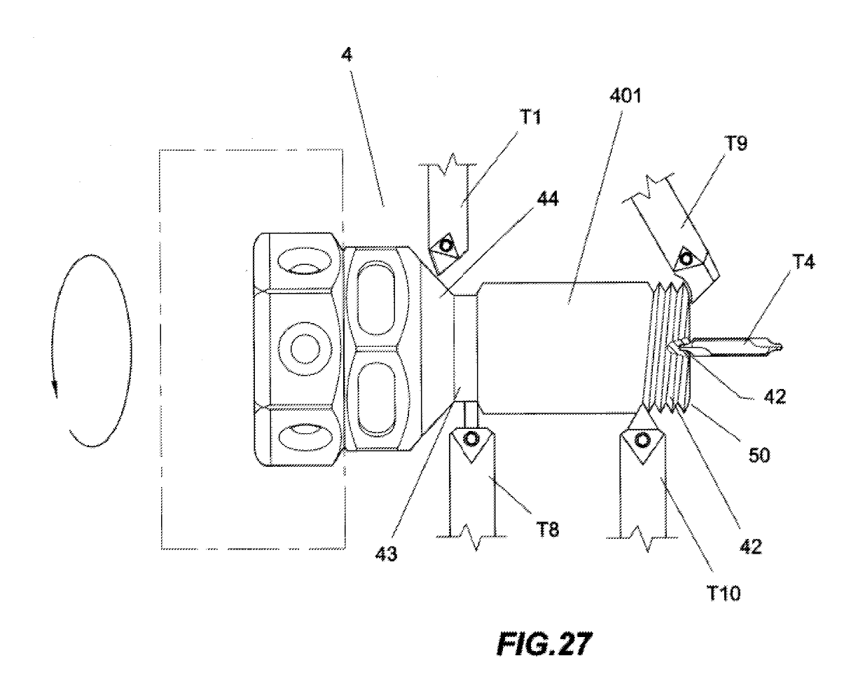

As illustrated in FIG. 8, an external insert 51 is adapted to execute external turning and facing for a raw material 4. As illustrated in FIGS. 9 and 17, a centering insert 52 is used for the turning of a V-groove 45 and a thread 42. To mill a polygon 46 is done with a face-milling insert 52 as illustrated in FIG. 10. A central hole 47 of the polygon 46 as illustrated in FIG. 11; an arc chamfer on the edge of the polygon as illustrated in FIG. 12; engraving of letters 49 as illustrated in FIG. 13; the turning of an arc on the end of an outer diameter and turning of an inclined plane of the outer diameter as illustrated in FIG. 14; and drilling of a central hole 41 on an end surface as illustrated in FIG. 15 are all done with a centering insert 53. As illustrated in FIG. 16, the turning of a round groove 43 and the milling of a long oval groove 48 as illustrated in FIG. 13 are done with a grooving insert 54.

In the prior art, it takes nine different tools to complete processing the same part 40 while the present invention needs only one tool adapted with four disposable inserts each giving particular function to complete the process. The present invention not only simplifying the process procedure in turning, milling and drilling but also significantly reducing the quantity of tools is original in the tooling industry.

As described above, the present invention while providing turning, milling and drilling functions to execute tasks of centering, drilling, chamfering, and V-grooving allows replacement of various types of disposable insert and engraving of a logo. The prevent invention permits multiple functions in one for the user to reduce the cost for maintaining a great number of tools. The structural design of a disposal insert allows repeated use of the insert for further reduction of production cost and improvement of competition strength and benefits. Mild amount of eccentric design assures of single sided operation of the cutting edge without causing friction thus to allow full utilization of each cutting edge of the insert to cash optimal benefits of practical use and advancement.

I claim:

1. A universal turning and milling tool applied in turning, milling, and drilling includes a tool blade with one end disposed with a holder to accommodate a disposable insert; the insert being locked in the holder with a screw; a threaded hole being disposed at the center of the holder; a bevel angle θ inclined downward being defined by the surface of the holder and the turning central line (T.C.L.) of the tool; and the proper bevel angle θ being defined between a screw hole central line of the threaded hole and the turning central line (T.C.L) of the tool.

2. The universal turning and milling tool as claimed in claim 1, wherein the screw hole central line (S.C.L.) of the threaded hole of the holder strays from the turning central line (T.C.L.) of the tool for a mild distance; and only a cutting edge of the insert straying from the T.C.L. operates to cut and another cutting edge on the other side of the insert is idled when the tool revolves.
